(19) United States
(12) Patent Application Publication
(10) Pub. No.: US 2007/0017111 A1
(43) Pub. Date: Jan. 25, 2007

(54) Light reflective and light enhancing tape measure

(76) Inventors: John F. Hoback, Anchorage, AK (US); Johnathan Hoback, Anchorage, AK (US)

Correspondence Address: Donald W. Meeker, 924 East Ocean Front #E, Newport Beach, CA, 92661, US

(21) Appl. No.: 11/187,194

(22) Filed: Jul. 21, 2005

(51) Int. Cl. G01B 3/10; G01C 15/06

(52) U.S. Cl. 33/771; 33/293

(57) ABSTRACT

A tape measure or other measuring surface has an attached pair of light enhancing reflective surfaces in conjunction with the numbers and measurement lines for use with rotating laser light instruments and light enhancement for readability. Reflective and glow in the dark surfaces may also be applied.

### BACKGROUND OF THE INVENTION

1. Field of the Invention

The present invention relates to measuring devices and particularly to a light-reflective and light-enhancing tape measure for reflection of a laser beam, the tape having a light reflective and light-enhancing surface over the distance marks and indicia on the tape.

2. Description of the Prior Art

Many years ago surveyors used a transit for determining the horizontal or azimuth angles as well as the vertical or elevation angles. A chain or tape measure was used to perform the actual distance measurement between the transit and the point to be established. In addition to this, the surveyor used a telescopic device called a horizontal level and a graduated rod for determining the actual elevation of a point or location in question.

Currently, in the art of surveying a parallel light or energy beam is used to determine a precise distance measurement. This beam can have an infrared or laser energy source. The current practice is to use a plastic sheet with a double line of highly reflective elements held up to stop a rotating laser beam on a laser level device with measurements made to the reflective elements and laser beam. It is awkward to hold the plastic reflective element and measure to it with a tape measure taking time and possibly producing inaccurate readings.

In low light conditions often existing on construction sites prior to installation of the electricity reading a tape measure can be challenging and may require a special light source for the purpose or moving an existing work light to the location of measurement.

None of the prior art devices adequately address these two problems.

U.S. Pat. No. D257,962, issued Jan. 20, 1981 to Youdelman, is for the ornamental design for a reflective height measuring device.

U.S. Pat. No. 4,029,415, issued Jun. 14, 1977 to Johnson, indicates a land-surveying apparatus for use with a laser beam source to obtain grade and range distances, which has a grade pole with a laser beam detection unit slidably mounted thereon, an electrical measuring means being connected between the grade pole and the detection unit to generate an electrical grade signal representative of the grade distance between a detector using an array of phototransistors and the base of the grade pole. A digital display unit receives the grade signal, processes it, and digitally, visibly displays the information contained in the signal. Electrical grade calculating circuitry is provided to process first and second grade signals containing the elevation of the upper and lower edges of the laser beam relative to the base of the pole and arithmetically process the signals to obtain the elevation of the laser beam center which is then displayed as the grade distance. Electrical range calculating circuitry is provided to selectively use information contained in the laser beam and generate a range output signal representing the range distance between the laser beam detector and the laser source, the range calculating circuitry delivering the range output signal to the digital display unit where the range distance is visibly, digitally displayed to the operator. The digital display unit is preferably housed in a control console which is pivotally mounted to the laser beam detection unit and also detachable from the detection unit to permit an operator to hold the control console, permitting easier reading of the digital display and more convenient operation of the console when the laser beam detection unit is at an inconvenient height on the grade pole.

U.S. Pat. No. 5,537,200, issued Jul. 16, 1996 to Kumagai, describes an electronic leveling apparatus and associated leveling staff that are capable of measuring the height difference of the positions automatically through the opto-electric conversion of the image of a pattern formed on the leveling staff. The apparatus has a turning drive means for turning it on a horizontal plane, a light emission means for emitting a light beam to the outside, a light reception means for receiving a reflected light of the emitted light beam, and a signal processor for controlling the turning drive means in response to the received signal so that the apparatus is oriented to the leveling staff automatically. The leveling staff used with the electronic level has a cyclic arrangement of a pattern set for electronic reading or a formation of a reflective strip. The reflective strip, which is a reflective tape in this embodiment, constitutes a reflector for reflecting a light beam in the direction opposite to the incident direction, and it reflects the light beam emitted by the light emission means of the electronic level.

U.S. Pat. No. 4,673,287, issued Jun. 16, 1987 to Rickus, discloses a laser-optical surveying system comprising a leveling system which uses a surveyor's rod wherein a laser beam rotates in a horizontal plane and is adapted to strike a surveyor's rod. The surveyor's rod is equipped with a coding representing the length in the case of a leveling system, or representing the altitude, which can be read with the laser light so that an optical signal representing the altitude is generated when the laser beam passes the rod. The latter is then converted to an electronic signal and serves, when electronically processed, for displaying the height of the laser beam on the surveyor's rod.

U.S. Pat. No. 5,142,793, issued Sep. 1, 1992 to Crane, provides a digital linear measuring device that includes a housing, a reel located within a housing and a measuring tape wound on the reel. The measuring tape is extendable through an opening in the housing as the reel is rotated. An incremental measuring means is associated with the reel for generating incremental measuring data and an absolute measuring means cooperates with the measuring tape for generating absolute measurement data as the measuring tape is extended. A processing unit is responsive to both the incremental measurement data and to the absolute measurement data for generating output reflecting linear extension of the measuring tape from the housing, and a display is responsive to the processing unit for displaying information reflecting the linear extension of the measuring tape from the housing. The measuring tape includes a reflective barcode that is read by an encoder, and in turn a signal processor unit will cause the display to show the exact blade length.

U.S. Pat. No. 5,027,526, issued Jul. 2, 1991 to Crane, shows a digital linear measuring device that includes a housing, a reel located within a housing and a measuring tape wound on the reel. The measuring tape is extendable through an opening in the housing as the reel is rotated. An incremental measuring means is associated with the reel for generating incremental measuring data and an absolute measuring means cooperates with the measuring tape for generating absolute measurement data as the measuring tape is extended. A processing unit is responsive to both the incremental measurement data and to the absolute measurement data for generating output reflecting linear extension of the measuring tape from the housing, and a display is responsive to the processing unit for displaying information reflecting the linear extension of the measuring tape from the housing. The measuring tape includes a reflective barcode that is read by an encoder, and in turn a signal processor unit will cause the display to show the exact blade length.

U.S. Pat. No. 2,171,504, issued Aug. 29, 1939 to Keuffel, claims a measuring tape, rule or other scales of the kind used by engineers, surveyors, carpenters, builders, carpet layers and others that measure distances. The measuring device has a graduated metal strip having a highly visible contrast between its raised graduations and its colored background.

U.S. Pat. No. 6,637,124, issued Oct. 28, 2003 to Pederson, illustrates an adhesive backed measuring tape that can provide customized, printed measurement scales on a single flexible backing that has a positionable or repositionable adhesive for contact with flat surfaces, single curved surfaces, or compound curved surfaces. In a preferred embodiment, the measuring tape has multiple scales printed thereon. The combination of linear sections and transverse axes defined by intervals can permit a variety of repeating scales on a single tape, minimizing waste of tape unrolled from a dispenser. The backing is selected from the group consisting of glossy materials, matte materials, metallic materials, reflective materials, retro-reflective materials, and luminescent materials.

U.S. Pat. No. 4,820,041, issued Apr. 11, 1989 to Davidson, is for a position sensing apparatus and method useful for surveying, marking, and grading implement sensing and control. The position sensing apparatus includes two laser reference stations, each of which projects a laser beam that periodically sweeps in a plane across the area to be surveyed. Each time a laser beam strikes the opposite reference station, a radio timing signal is broadcast by that reference station. The position sensing apparatus also includes a portable sensing station that comprises a laser beam receiver, a radio receiver, and a programmed computer. The planar position of the portable sensing station relative to the reference stations is computed by a triangulation technique based on the relative timing of detection of the laser beams by the laser beam receiver and the reception of the radio timing signals by the radio receiver. Elevation is determined according to the height at which one of the laser beams strikes the laser beam receiver. One embodiment of receiver includes an extensible rod, an extension measuring device, a laser receiver, a radio receiver, and a receiving antenna. The extensible rod serves to support the laser receiver at the proper elevation for intercepting the laser beams. The extension measuring device, which can be as simple as a tape measure, provides means for determining the height at which the datum laser beam intersects the laser receiver according to the extension of the extensible rod.

U.S. Pat. No. 4,030,832, issued Jun. 21, 1977 to Rando, provides a grade rod and method of operation for use in a surveying system employing a laser beam which is rotated in a plane. A flexible tape formed with a graduated scale is mounted for movement in a loop within the housing. A slider on the tape carries a pair of closely spaced-apart light detectors as well as electronic circuitry which discriminates between laser beam pulses and sunlight. Output signals from the circuitry on the slider are fed into a control circuit in the housing through a flexible cable which is carried in a traveling loop. Scale indicators are mounted for movement with the slider along a fixed scale which is provided on the housing, and a manually operated cursor is mounted for movement along the housing. The control circuit includes means for driving the tape and slider in a search mode until a light pulse from the laser hits a detector, and then in a track mode for centering the detectors on the plane of the laser beam. A circuit is provided for returning the slider to its home position should the beam be interrupted for a period of time, and also for returning the slider to its home position should no laser beam be detected. A stutter-start circuit is employed for operation in a track mode for a short time period after activation before switching to the search mode.

What is needed is a reflective light-enhancing tape measure for use with a laser height measuring instrument and general measurements in low light with a highly reflective and light-enhancing layer over the numbers and distance marks on at least a portion of the tape measure for easy reading.

### SUMMARY OF THE INVENTION

An object of the present invention is to provide a reflective light-enhancing tape measure for use with a laser height measuring instrument and general measurements in low light with a highly reflective and light-enhancing layer over the numbers and distance marks on at least a portion of the tape measure for easy reading in any light condition and ease of use with a rotating laser light measuring instrument.

Another object of the present invention is that the reflective light-enhancing coating may be applied to any measuring device, however its most practical purpose currently involves its use on a tape measure, one such as a builder, framer, contractor, subcontractor might use: 8, 16, 24, 30 plus retractable tape measures.

In brief, a measuring tape has an outer surface over the numbers and measurement lines that is highly reflective for use with rotating laser light leveling and surveying instruments and has light gathering qualities to enhance the light quality and intensity on the measurements and lines for easier reading of the measurements even in dim light. Either a strip running up the tape, the first ten feet of the tape, or the entire tape, is designed to reflect light. As a road or freeway sign reflects back head lights, the measuring tape reflects back light. The color of the face of the tape can be any bright color which reflects back any form of light shown on it.

Any source of light will enhance visibility and in turn readability of a measuring device with the coating of the present invention, especially in low light environments and circumstances when a source of light directed toward the measuring tape (device) will cause it to light up, or intensify it's readable qualities. Any source of light directed at the tape will light up the unit through reflection making more visible the measure indicators. The background on which the numbers and lines are placed may be light gathering and light reflective as well as the units of measure numbers.

Although the characteristics of this measuring device will aid its readable qualities when a light source is directed towards it, a primary characteristic will be the aid to determine unit measurement with the use of a laser light (to precise measurements) at greater distances from the light source and in a shorter time with less effort than with currently used methods and devices.

The present invention may further comprise reflective and glow in the dark surfaces as well so that as a laser or bright light passes across a glow in the dark tape measure surface the marker will stay lit even after the laser or light is not shining on the tape (for a brief period of time) to mark a spot. For example, a thin strip of glow in the dark coating may extend down the center of the tape between the reflective strips.

An advantage of the present invention is that it provides easy reading in any light condition and ease of use with a rotating beam laser light measuring instrument.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a schematic view of the highly reflective and light enhancing tape measure of the present invention being used with a laser level instrument for a one-step measuring process;

FIG. 2 is a schematic view of the prior art system of using a plastic strip with a pair of spaced highly reflective surfaces on the strip for stopping a rotating laser level beam and then requiring holding the piece of plastic still while trying to take measurements with a standard tape measure;

FIG. 3 is a perspective view of the highly reflective and light enhancing tape measure of the present invention showing the two spaced strips of highly reflective light enhancing material over the measuring lines along the two edges of the tape measure;

FIG. 4 is an elevational view showing a section of the tape measure of the present invention with a laser beam hitting a point on the tape.

### BEST MODE FOR CARRYING OUT THE INVENTION

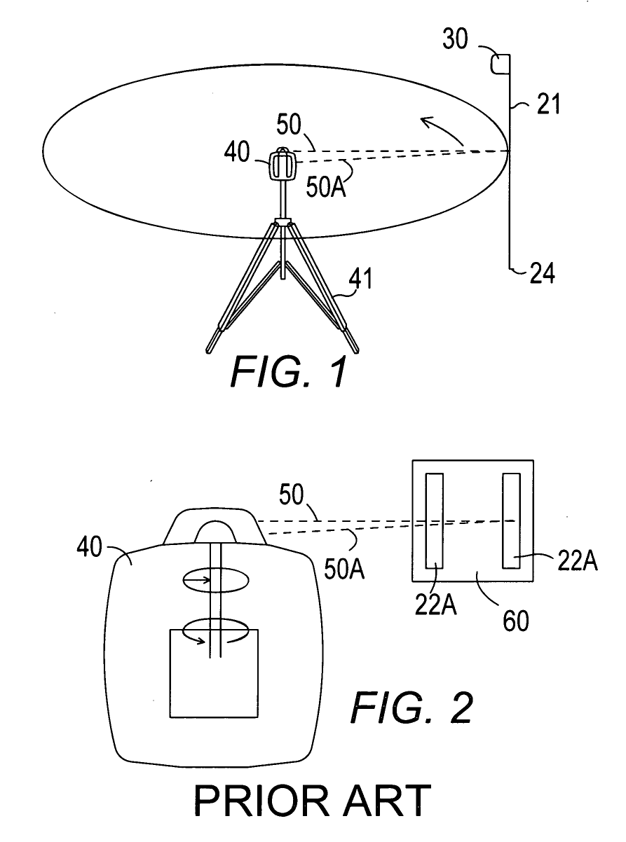

In FIGS. 1 and 3-5, a light enhanced reflective measuring device 20 is coated for clear readings in various light conditions and for use with rotating laser light equipment 40.

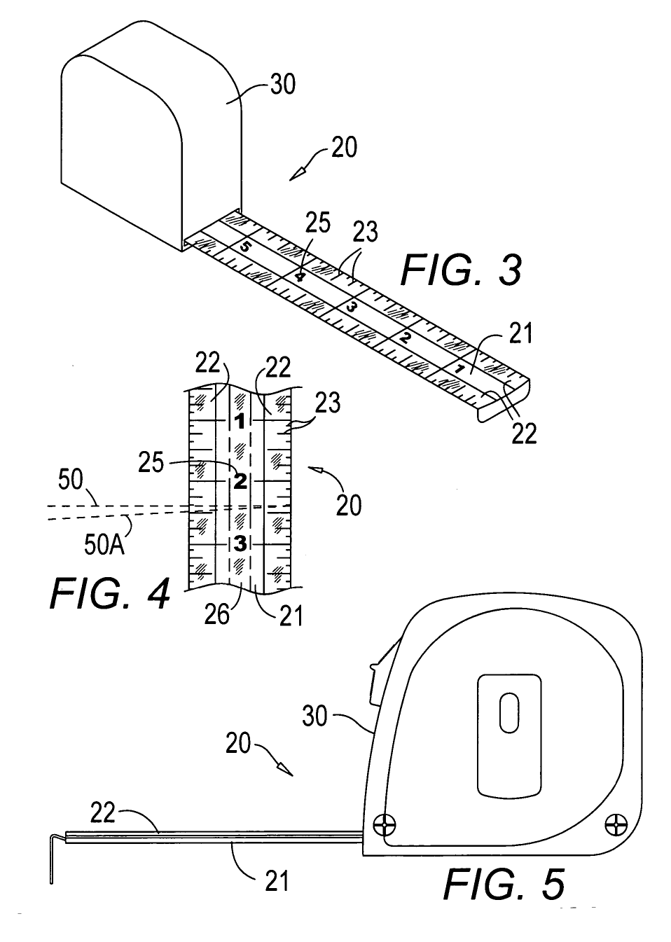

In FIGS. 3-5, an elongated measuring surface 21, preferably on a retractable tape measure 30, comprises indicia imprinted thereon in a series of spaced lines 23 and related numbers 25 for measuring distances and a pair of spaced light enhancing reflective surfaces 22 attached to the measuring surface over at least a portion of the length of the measuring surface 21 in conjunction with the indicia.

The spaced light enhancing reflective surfaces 22 have light gathering and reflective qualities, similar to the qualities of reflective road signs and reflective surfaces 22A, in FIG. 2, currently used on a plastic strip 60 in conjunction with a rotating laser instrument 40 to stop the laser beam 50 (reflected back to the instrument in a reflected beam 50A) for measuring a height using a separate measuring implement. The spaced light enhancing reflective surfaces 22 enhance the light quality and intensity on the indicia 23 and 25 for easier reading of the indicia in various external light conditions. The spaced light enhancing reflective surfaces 22 are highly reflective for use with rotating laser leveling and surveying instruments 40 to stop the rotation of the laser light 50 (and corresponding reflected laser light beam 50A) when the laser light beam 50 strikes the spaced light enhancing reflective surfaces 22, as seen in FIG. 4. The distances can then be measured directly on the light enhanced reflective measuring device 20 itself rather than requiring a separate measuring device.

The pair of spaced light enhancing reflective surfaces 22 may be attached to a length of the tape measure at an outer end of the tape measure, such as the first ten feet of the tape measure 30 or any other type of measuring surface 21 or over the entire length of the measuring surface.

The pair of spaced light enhancing reflective surfaces 22 may comprise colored light enhancing reflective surfaces for easier use in various lighting conditions to enhance visibility of the indicia.

The light enhancing reflective surfaces 22 may be positioned over the indicia 23 and 25 with the indicia imprinted on the measuring surface 21 and the light enhancing reflective surfaces attached over the indicia by an adhering or liquid coating or heating process. Alternately the light enhancing reflective surfaces 22 may be positioned under the indicia with the light enhancing reflective surfaces 22 attached first to the measuring surface 21 and the indicia 23 and 25 imprinted or otherwise attached over the light enhancing reflective surfaces.

The indicia 23 and 25 may also be formed of light enhancing reflective material.

In FIG. 4, a length of reflective glow in the dark material 26 may also be attached to at least a portion of or the entire length of the measuring surface 21, preferably along a center of the measuring surface 21 between the pair of spaced light enhancing reflective surfaces 22, to retain light on the reflective glow in the dark material after a light source has shined thereon and then been removed for a period of time to mark a spot.

A conventional measuring tape may have the pair of light enhancing reflective material strips applied to it as well as the reflective glow in the dark material or the measuring tape may be custom fabricated with the pair of light enhancing reflective material strips applied to it as well as the reflective glow in the dark material if desired.

It is understood that the preceding description is given merely by way of illustration and not in limitation of the invention and that various modifications may be made thereto without departing from the spirit of the invention as claimed.

What is claimed is:

1. A light enhanced reflective measuring device for clear readings in various light conditions and for use with rotating laser light equipment, the device comprising:
an elongated measuring surface comprising indicia imprinted thereon in a series of spaced lines and related numbers for measuring distances and a pair of spaced light enhancing reflective surfaces attached to the measuring surface over at least a portion of the length of the measuring surface in conjunction with the indicia, the spaced light enhancing reflective surfaces having light gathering qualities to enhance the light quality and intensity on the indicia for easier reading of the indicia in various external light conditions, the spaced light enhancing reflective surfaces being highly reflective for use with rotating laser leveling and surveying instruments to stop the laser light rotation when the laser light strikes the spaced light enhancing reflective surfaces.

2. The device of claim 1 wherein the elongated measuring surface comprises a tape measure.

3. The device of claim 2 wherein the pair of spaced light enhancing reflective surfaces are attached to a length of the tape measure at an outer end of the tape measure.

4. The device of claim 2 wherein the pair of spaced light enhancing reflective surfaces are attached to the entire length of the tape measure.

5. The device of claim 1 wherein the pair of spaced light enhancing reflective surfaces are attached to the entire length of the elongated measuring surface.

6. The device of claim 1 wherein the pair of spaced light enhancing reflective surfaces comprise colored light enhancing reflective surfaces.

7. The device of claim 1 wherein the light enhancing reflective surfaces are positioned over the indicia.

8. The device of claim 1 wherein the light enhancing reflective surfaces are positioned under the indicia.

9. The device of claim 1 wherein the indicia is formed of light enhancing reflective material.

10. The device of claim 1 further comprising at least one length of reflective glow in the dark material attached to at least a portion of the length the measuring surface to retain light on the reflective glow in the dark material after a light source has shined thereon and then been removed for a period of time to mark a spot.

11. The device of claim 10 wherein a thin strip of reflective glow in the dark coating extends along a center of the measuring surface between the pair of spaced light enhancing reflective surfaces.
